(19) United States
(12) Patent Application Publication
(10) Pub. No.: US 2025/0091811 A1
(43) Pub. Date: Mar. 20, 2025

(54) CONVEYOR BELT SUPPORT SYSTEM AND APPARATUS

(71) Applicant: Flexible Steel Lacing Company, Downers Grove, IL (US)

(72) Inventors: Jeremy Ross Van Baren, Ada, MI (US); Noel Francis Cormier, Grand Rapids, MI (US); Joshua Taggart, Chase, MI (US)

(21) Appl. No.: 18/890,234

(22) Filed: Sep. 19, 2024

Related U.S. Application Data
(60) Provisional application No. 63/539,477, filed on Sep. 20, 2023.

(51) Int. Cl. B65G 21/20; B65G 15/62

(52) U.S. Cl. CPC B65G 21/20; B65G 15/62; B65G 2207/08

(57) ABSTRACT

A belt support apparatus for supporting a conveyor belt may include at least one support arm assembly operably connected to a base member. A slider bar having a belt support surface for supporting the conveyor belt is connected to a distal end portion of the at least one support arm assembly. In one form, the support arm assembly is configured to allow the belt support surface of the slider bar to be moved relative to the base member in different lateral and vertical positions via a plurality of different modes of adjustment. The plurality of different modes of adjustment may include movement of the slider bar in an arcuate path relative to the base member and translational shifting of the slider bar, including in an oblique direction that extends obliquely relative to a vertical direction and a lateral direction perpendicular to a conveyor belt travel direction.

### CROSS-REFERENCE TO RELATED APPLICATION

This application claims the benefit of U.S. Provisional Application No. 63/539,477 filed Sep. 20, 2023, which is incorporated herein by reference in its entirety.

### TECHNICAL FIELD

This disclosure relates to an apparatus and system for supporting a conveyor belt traveling thereover and, more particularly, to an adjustable conveyor belt support apparatus for supporting a lateral portion of the conveyor belt.

### BACKGROUND

Generally, a loading zone or transfer area of a conveyor belt, where material to be conveyed is deposited and collected on the conveyor belt, should be supported to avoid damage to the conveyor belt, to keep conveyed material from falling off of the belt and to control dust and debris as the conveyed material settles on the belt. Various belt support devices, such as impact beds, slider beds and idler rollers are used to support the belt in the transfer area. These support devices generally support the conveyor belt in a troughed or U-shape such that the lateral edges of the belt are raised with respect to the center of the belt.

Often skirting systems are provided at either lateral side of the conveyor belt in the transfer area to keep conveyed material from falling off the belt and to keep dust and debris contained in the area above the belt. A skirting system may include urethane or rubber skirting that is supported and arranged generally vertically at each lateral side of the belt and which curves inwardly toward the center of the belt to direct conveyed material, dust, and debris away from the edge of the belt. The skirting generally contacts the top surface of the belt near each lateral edge to inhibit material spillage and control dust. However, gaps between the skirting and the conveyor belt can form, particularly in areas of the belt between longitudinally spaced sets of idler rollers that are spaced from each other in the downstream direction of travel of the conveyor belt where the belt sags, allowing material and dust to escape. It is often impractical and/or cost prohibitive to deploy additional idler roller sets or other known belt support devices to address this problem.

One known support device having opposing slider bars can be positioned under the belt between adjacent idlers or other support devices is disclosed in U.S. Pat. No. 4,898,272. The support device includes a large, integrated frame assembly that includes opposite, elongated slider bars with the frame assembly being fixedly mounted to conveyor support structure between adjacent sets of idler rollers so the slider bars can be positioned underneath each lateral edge of the belt for contacting the underside edges of the conveyor belt in substantially the entire area between the idler roller sets. Each slider bar is supported by a pair of U-shaped support frames of the frame assembly with the support frames each sized to extend transversely across the entire lateral width of the conveyor belt. The support frames are longitudinally spaced apart from one another in the conveyor belt travel direction between the adjacent sets of idler rollers. Each U-shaped support frame includes a pair of stationary upright support posts that are affixed at and extend upwardly from the lateral ends of a crossbar or strut which is sized to extend across the width of the conveyor belt to interconnect the support frames. To install the frame assembly, the crossbars are each fastened to an upper horizontal leg of stringers of the conveyor support structure that extend longitudinally along the length of the conveyor belt on opposing sides thereof. Each stationary upright support post includes an upper telescoping tube member to allow the height of the slider bar to be adjusted.

In addition, each slider bar has opposite end portions connected to longitudinally-aligned posts along one side of the conveyor belt. Thus, the upper telescoping tube member of one of the support frames is connected to one end portion of a slider bar and the other end portion is connected to the longitudinally aligned upper telescoping tube member of the other support frame via rotatably moveable holders, which allow the angle of the slider bar to be adjusted relative to the telescoping tube members along one side edge of the belt. As is apparent, the slider bars also interconnect the support frames along with the crossbars to form a relatively large rectangular footprint for the integrated frame assembly of the '272 patent. In this regard, the size of the integrated frame assembly in the belt travel direction is set based on the length of the slider bars, which are determined based on the distance between adjacent sets of idler rollers. And the size of the integrated frame assembly in the lateral direction is set based on the length of the crossbars, which are determined based on the width of the conveyor belt.

### SUMMARY

There are disadvantages associated with such support devices described above. For example, due to the U-shaped support frames which extend across the width of the conveyor belt, the support devices are limited in where they can be installed and can be difficult and time consuming to install. And because the width of conveyor belts and their associated support structures vary between different conveyor systems, the support device described above must be customized to fit each different width. Likewise, because distances between adjacent sets of idler rollers can vary in different conveyor belt systems, different sizes of integrated frame assemblies including their slider bars will need to be used. Further, the sliders are limited with respect to the locations in which they can be installed relative to the conveyor belt as the crossbar is configured to be fastened to the horizontal surface of the upper leg of the stringers of the support structure of the conveyor belt. However, the conveyor support structure can vary significantly depending on the conveyor system, and the availability of a horizontal mounting surface cannot always be counted on.

In addition, because the U-shaped support frame extends across the width of the conveyor belt underneath the belt, the conveyor belt will normally need to be lifted to fit the support device thereunder. This typically requires a belt lifting device, which may necessitate multiple workers to position and operate. In addition, adjacent sets of idler rollers may also need be temporarily removed in order to install such a support device. Alternatively, without lifting of the belt or removal of the idler rollers, it is still difficult to manipulate the U-shaped support frames to be fit under and across the belt for installation at either side thereof.

Furthermore, the support posts of the support devices are laterally fixed to the lateral ends of the crossbars and therefore positioned at a fixed lateral location under the conveyor belt. As such, the slider bars may be necessarily located at a lateral position either laterally outside or inside of where the skirt walls of a skirting system are located. In such instances, the slider bars would not press the conveyor belt upwardly into contact with the skirting walls thereabove so that the belt edge is captured therebetween. Thus, any gap between the belt edge and the corresponding skirt wall may not be effectively closed by the slider bars as desired.

In accordance with one aspect of the present disclosure, a system and apparatus are provided for supporting a lateral or side edge of a conveyor belt. In one form, the conveyor belt support apparatus advantageously has a plurality of different modes of adjustment, such as at least three modes of adjustment, to allow a belt support surface thereof, such as the top surface of a slider bar, to be oriented in a wide variety of different vertical and lateral positions and different orientations underneath the side edge of the belt for supporting the belt so that it can be pinched or clamped between the slider bar and the bottom of an overlying skirt wall. In some forms, the plurality of different modes of adjustment include movement of the slider bar in an arcuate path relative to the base member and translational shifting of the slider bar in an oblique direction that extends obliquely relative to a vertical direction and a lateral direction, wherein the lateral direction is perpendicular to the belt travel direction. The conveyor belt support apparatus can have a base with a relatively small footprint which allows it to be mounted to conveyor belt support structure having various configurations and in relatively tight spaces, if necessary. The conveyor belt support apparatus also advantageously supports only a single side edge of the conveyor belt so that no transverse structure, such as a crossbar or strut, extends across the belt to be connected to conveyor support structure adjacent the other side edge of the belt, such as for another conveyor belt support apparatus thereat. In this manner, the conveyor belt support apparatus may be used independent of any other conveyor belt support apparatus, which greatly increases its flexibility to be used in a broad range of applications and conveyor system configurations. For example, the support apparatus described herein may be mounted to a horizontal surface, a vertical surface, or surfaces of other orientations, with adjustments being made so that the belt support surface can still be properly oriented to support the belt edge. In addition, because each conveyor belt support apparatus is highly adjustable and may be installed in a wider variety of locations, the support apparatus is highly independent of the conveyor system configuration and may be produced in larger quantities without need for customization, which increases efficiency and lowers production costs.

The exemplary conveyor belt support apparatuses may also be installed and adjusted by a single user. With the conveyor belt support apparatus herein there is no need to lift the belt, as can be required with the previously-described prior art support device that has frames of a frame assembly that span the entire transverse width of the conveyor belt. Likewise, there is no need for manipulating the conveyor belt support apparatus herein to be fit under the conveyor belt for extending thereacross. And due to its relatively small footprint along one side of the conveyor belt, installation of the exemplary conveyor belt support apparatuses does not require temporary removal of adjacent idler rollers. In addition, the conveyor belt support apparatus herein may be of a more compact size than known belt support devices, which allows for more precise and localized support of the belt where such support is needed, such as at a gap between the belt and any skirting that only extends a small longitudinal distance, and which also reduces friction with the belt relative to the prior art belt support device which contacts the belt along a majority of its length between adjacent idler roller sets.

In addition, the slider bars may be laterally adjusted to both ensure support of the belt and to be positioned under a skirting system. More particularly, the slider bars may be laterally adjusted such that they press the belt into contact with the skirting system. In this way, the laterally-adjustable support apparatus allows a user to reduce or eliminate gaps between the belt and a skirting system, thereby reducing the amount of conveyed material, dust, or debris that may fall laterally off of the conveyor belt. Advantageously, this lateral adjustment of the conveyor belt support apparatus relative to the belt and skirting system may be performed by a single user.

### BRIEF DESCRIPTION OF DRAWINGS

FIG. 1 is a perspective view of an exemplary conveyor belt support system showing a pair of conveyor belt support apparatuses (one in phantom) mounted to opposing stringers of a conveyor system frame underneath a troughed conveyor belt for supporting opposing lateral sides of the conveyor belt;

FIG. 2 is a perspective view of one of the conveyor belt support apparatuses of FIG. 1 showing a slider bar mounted to a slider bar mounting member, which in turn is rotatably connected to a pair of support arm assemblies in the form of telescoping support arms, which are rotatably mounted to a base member;

FIG. 3 is a perspective view of the conveyor belt support apparatus of FIG. 2 showing an opposite side thereof including T-shaped channels formed in the slider bar for mounting the slider bar to the slider bar mounting member;

FIG. 4 is an elevational view of the conveyor belt support apparatus of FIG. 2 showing a bottom surface of the base including a flat, lower mounting plate portion having a channel formed therein for allowing fasteners to be adjustably positioned therein for coupling the base member to a stringer or other frame structure of the conveyor belt;

FIG. 5 is an exploded perspective view of the slider bar and slider bar mounting member showing T-shaped channels formed in a lower portion of the slider bar and arcuate channels formed in opposing, downwardly extending trunnion portions of the slider bar mounting member, the arcuate channels including a plurality of small, ridge projections configured to cooperate with guide bolts positioned in the arcuate channels for resisting rotational movement of the slider bar and slider bar mounting member relative to the telescoping support arms;

FIG. 6 is a perspective view of another conveyor belt support apparatus showing a slider bar assembly including a slider bar mounted to a slider bar mounting base, with the slider bar mounting base connected to a slider bar mounting member, which in turn is connected to a pair of support arm assemblies including movable support arms, which are adjustably mounted to a pair of stationary upright support arms to form, combination translation, pivot and articulation connections therewith with the stationary support arms being fixedly mounted to a base member;

FIG. 7 is a side elevational view of the conveyor belt support apparatus of FIG. 6 showing a T-shaped channel of the slider bar mounting base for receiving fasteners for connecting the slider bar mounting base to the slider bar support member;

FIG. 8 is an exploded perspective view of the slider bar assembly showing the slider bar, slider bar mounting base, opposing end caps, and fasteners thereof.

### DETAILED DESCRIPTION

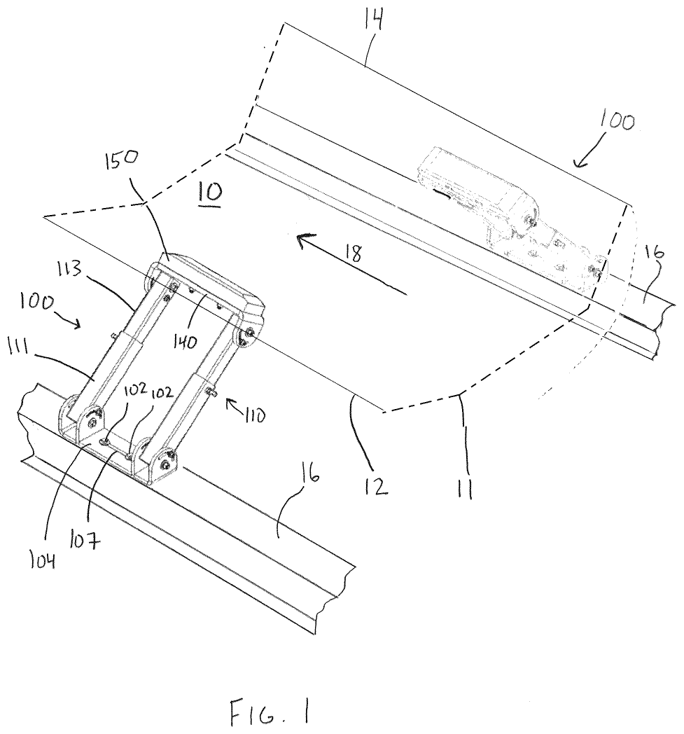

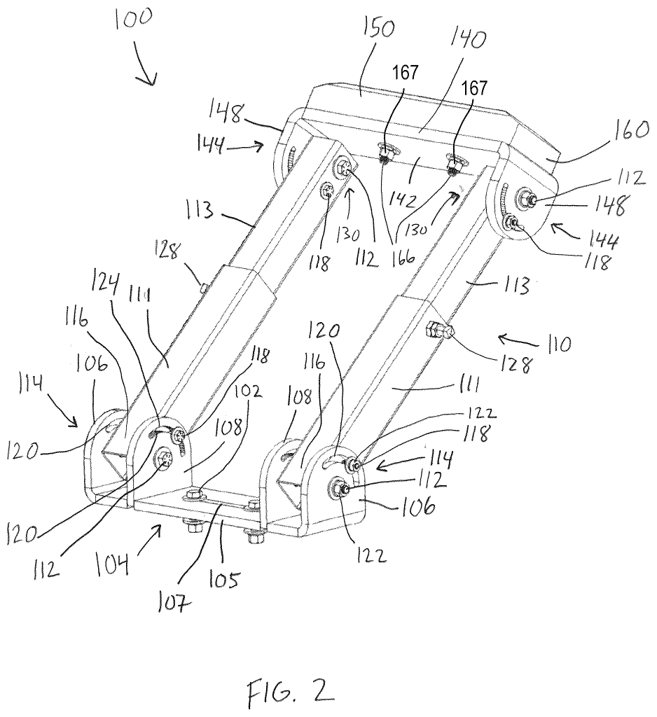

In one preferred form shown in FIG. 1, a pair of conveyor belt support apparatuses 100 in accordance with the present invention support an underside 11 of a conveyor belt 10 at each lateral side 12, 14 thereof. Each conveyor belt support apparatus 100 is mounted with fasteners such as bolts 102 to frame structure of the conveyor belt system, such as stringers 16 thereof. As shown in FIG. 2, the conveyor belt support apparatus 100 includes an elongate base member 104 to which a pair of support arm assemblies in the form of spaced-apart telescoping support arms 110, each formed by lower and upper support arm members 111, 113, are rotatably connected. In particular, the support arms may include the upper support arm member 113 adjustably received inside of the lower support arm member 111 in a telescoping manner. The arm members 111, 113 can have a tubular construction such as with the illustrated rectangular or square cross-sectional configuration. An elongate slider bar mounting member 140 is rotatably connected to upper end portions of the upper support arms 113, and a slider bar 150 of a low friction, abrasive resistant material is connected to the elongate slider bar mounting member 140. The slider bar 150 may be formed, for example, of a ultra-high molecular weight polyethylene (UHMW).

A first mode of adjustment of the conveyor belt support apparatus 100 and the slider bar 150 thereof is pivotal or rotational, and the rotational adjustment is accomplished via a rotatable pivot connection 114 between the elongate base member 104 and the support arms 110. In the illustrated form, the elongate base member 104 includes two pairs of spaced apart trunnions 106, 108 at each end of a flat lower mounting plate portion 105 of the base member 104. The upwardly extending trunnions 106, 108 rotatably couple the lower support arm members 111 to the elongate base member 104.

The trunnions 106, 108 are plate-like members having a generally arcuate upper edge and that extend perpendicularly upward from a rectangular mounting plate portion 105 of the elongate base member 104, with outer end trunnions 106 formed by bending each end of the mounting plate portion 105 upward and inner trunnions 108 fixedly connected to the base portion 105, such as by welding, to be spaced from the adjacent outer end trunnion 106. An elongate slot 107 extends longitudinally along the mounting plate portion 105 of the elongate base member 104 between the inner trunnions 108 through which mounting bolts 102 are inserted for coupling the elongate base member 104 to the stringer 16, which allows the mounting bolts 102 to be adjustably positioned along the length of the elongate base member 104.

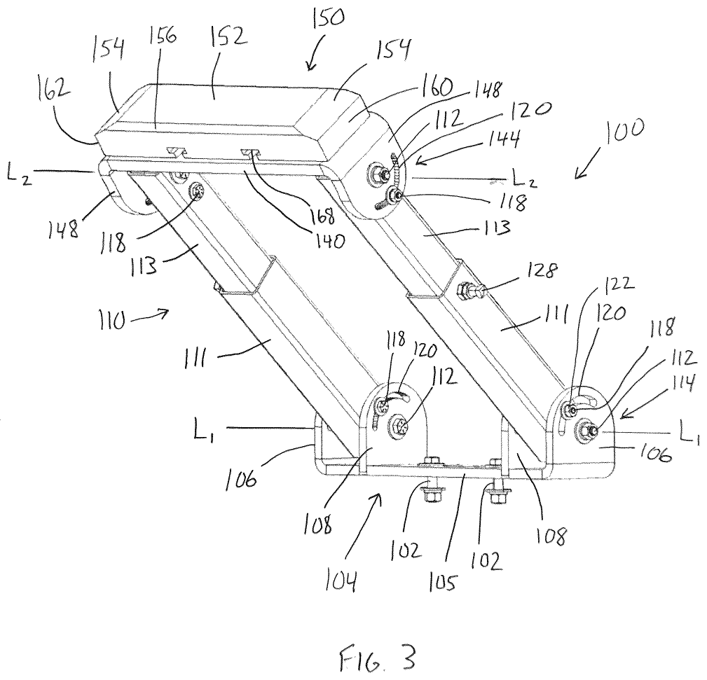

Each trunnion pair 106, 108 forms a rotatable pivot connection 114 with the corresponding lower support arm member 111. Each rotatable pivot connection 114 includes an elongate pivot member such as bolt 112 that extends through a through-opening formed in the trunnions 106, 108 and through corresponding aligned through openings formed in a proximal end portion 116 of the lower support arm 111. Accordingly, as shown in FIG. 3, the lower support arm members 111 are pivotable about a longitudinally-oriented (with respect to conveyor belt 10) pivot axis L1 extending through the pivot bolts 112. A guide member in the form of bolt 118 extends through arcuate channels 120 formed in each trunnion pair 106, 108 and through openings formed in the proximal end portion 116 of the lower support arm member 111. The arcuate channels 120 have a constant radius of curvature where the center is located at the through openings for the pivot bolt 112. The arcuate channels 120 and guide bolts 118 define the range of rotational movement of the support arms 110, and are sized to provide the desired range, such as at least 90 degrees, as illustrated. Similar arcuate channels 120 are formed in trunnions 148 of the slider bar mounting member 140. Instead of bolts, the pivot members and guide members may take other forms, including pins, shafts, rods, fasteners, and the like.

The range of rotational movement of the support arms 110 may be further increased by temporarily removing the guide bolts 118 from the arcuate channels 120. This can be useful during installation of the conveyor belt support apparatus 100 and/or to allow ease of replacing the slider bar 150 by allowing the support arms 110 to be pivoted further inwardly under the conveyor belt 10 or laterally outwardly away from the conveyor belt 10 without need to remove the conveyor belt support apparatus 100 from the stringers 16.

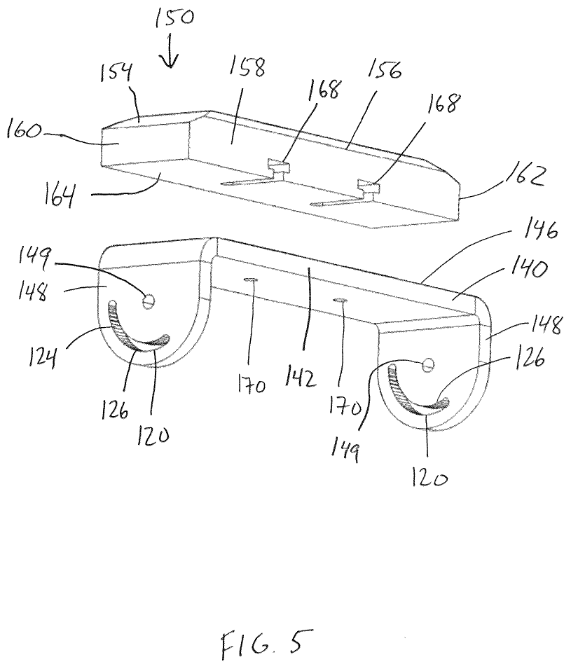

The angular orientation of the support arms 110 relative to the trunnions 106, 108 can be fixed by clamping the proximal end portions 116 of the lower support arms 111 between the trunnions 106, 108. This can be accomplished by tightening corresponding nuts 122 onto guide bolts 118, and optionally tightening nuts 122 onto pivot bolts 112, until a sufficient clamping force is achieved. In addition, as best seen in FIG. 5 with respect to slider bar mounting member 140, the arcuate channels 120 may advantageously be provided with anti-rotation features to inhibit rotation of the support arms 110 relative to the base member 104 and/or to inhibit rotation of the slider bar mounting member 140 relative to the support arms 110. The anti-rotation features may take the form of a plurality of small, ridge projections 124 formed in opposing side surfaces 126 extending along arcuate channels 120. The projections 124 may be spaced so that adjacent ones of the projections 124 on opposing sides surfaces 126 tightly engage with a guide member 118 received therebetween. In particular, the spacing between opposing projections 124 on each side surface 126 is selected to be smaller than the diameter of guide bolt 118 such that there is an interference fit between the opposing side surfaces 126 of the arcuate channel 120 and the guide bolt 118 at least at each projection 124. Accordingly, a small to moderate amount of elastic deformation of the arcuate channel 120 and/or guide bolt 118 is required to shift the guide bolt 118 within the arcuate channel 120. The projections 124 may be formed by the intersection of non-parallel straight surface portions that intersect at a peak of the ridge projections and extend transversely across the channel 120 or arcuate portions of the side surface 126 that generally match the curvature of the bolt shank surface and extend transversely across the channel 120. Alternatively, instead of a continuous arcuate channel 120, separate spaced apart circular through openings arranged in an arc similar to the shape of the arcuate channels 120 may be formed in the trunnions 106, 108, 148 to allow discrete angular adjustment of the support arms 110 and/or the elongate slider bar mounting member 140.

A second mode of adjustment of the conveyor belt support apparatus 100 and the slider bar 150 thereof is translational along a longitudinal axis of the support arms 110 such that the height of the slider bar 150 may be longitudinally adjusted relative to the mounting plate portion 105. In particular, the position of the slider bar 150, extending transversely to the longitudinal axes of the upper and lower support arms, 111, 113, may be moved across the width of the belt 10 toward or away from the center of the belt as well as vertically for height adjustment by increasing or decreasing the length of each support arm 110. The length of the support arm 110 may be adjusted by shifting the upper support arm member 113 in either longitudinal direction with respect to the lower support arm member 111, either into or out of the interior of the lower support arm 111. The position of the upper support arm member 113 may be fixed relative to the lower support arm 111 via a set screw 128. In the approach shown, the set screw 128 extends through an upper portion of the lower support arm member 111 such that the set screw engages a desired portion of the upper support arm member 113 depending on the adjustment thereof relative to the lower support arm 111. Alternatively, a series of transverse, aligned through-openings may be formed along the length of the opposing side walls of the upper support arm member 113 to receive a pin or other fastener to provide a plurality of discrete fixation positions of the upper support arm member 113. The lower and upper support arm members 111, 113 are shown as concentric square tube members but may take other forms, such as angle bars. In addition, while the support arm 110 shown has one telescoping upper support arm member 113, the support arm 110 may be provided as a single member or may have more than one telescoping member to increase the range of adjustability of the conveyor belt support apparatus 100.

The slider bar 150 is mounted to the elongate slider bar mounting member 140, which has a generally rectangular upper mounting surface 146 for supporting the similarly configured slider bar 150 in engagement with the conveyor belt 10. The third mode of adjustment of the slider bar 150 is rotational or pivotal and is accomplished via a rotatable pivot connection 144 between the upper support arm members 113 and the elongate slider bar mounting member 140 in a similar manner to the rotatable pivot connection 114 of the lower support arm members 111 and the trunnions 106, 108 of the elongate base member 104.

In particular, the elongate slider bar mounting member 140 includes trunnions 148 extending perpendicularly downwardly from the ends of the rectangular main body portion 142. Pivot members in the form of bolts 112 about which the elongate slider bar mounting member 140 is pivotable each extend through a through opening 149 formed in each trunnion 148 and through corresponding aligned through openings formed in the sidewalls of the distal end portion 130 of the corresponding upper support arm 113. Accordingly, the elongate slider bar mounting member 140 is pivotable about a second and upper longitudinally-oriented pivot axis L2 extending through the pivot bolts 112 and parallel to the lower pivot axis L1 and parallel to the lower pivot axis L1. A guide bolt 118 extends through an arcuate channel 120 formed in each trunnion 148 and through aligned through openings formed in the sidewalls of the distal end portion 130 of the upper support arm member 113 in a similar manner as described above with respect to the elongate base member 104. In general, the rotatable pivot connections 114, 144 may be sized and oriented to allow the slider bar 150 to be adjusted from a horizontal orientation to a vertical orientation to allow the slider bar 150 to support the belt 10 in any of a wide variety of positions as needed. In most cases however, the slider bar 150 will be positioned close to a lateral side 12, 14 of a troughed belt, where the belt is typically oriented at an angle of between 20 and 45 degrees with respect to horizontal. Likewise, due to the adjustability of the belt support apparatus 100, the base mounting plate 105 can be fastened to surfaces having a variety of orientations beyond just horizontal mounting surfaces while still allowing the slider bar 150 to be positioned under either of the belt side edges 12 or 14 to keep it close to or in engagement with the bottom of the corresponding skirt wall.

As mentioned, the slider bar 150 is preferably of a low friction, abrasion resistant material, such as ultra-high molecular weight polyethylene (UHMW). Slider bar 150 has a generally rectangular prismatic shape with a top surface 152 for engaging with the underside of the conveyor belt 10. Beveled surface portions 154 are positioned at each end between the top surface 152 and the leading and trailing end surfaces 160, 162 to reduce friction with the belt 10 and to prevent catching on splices or other protrusions on the underside of the belt 10. Narrower beveled surface portions 156 extend between the top surface 152 and lateral side surfaces 158.

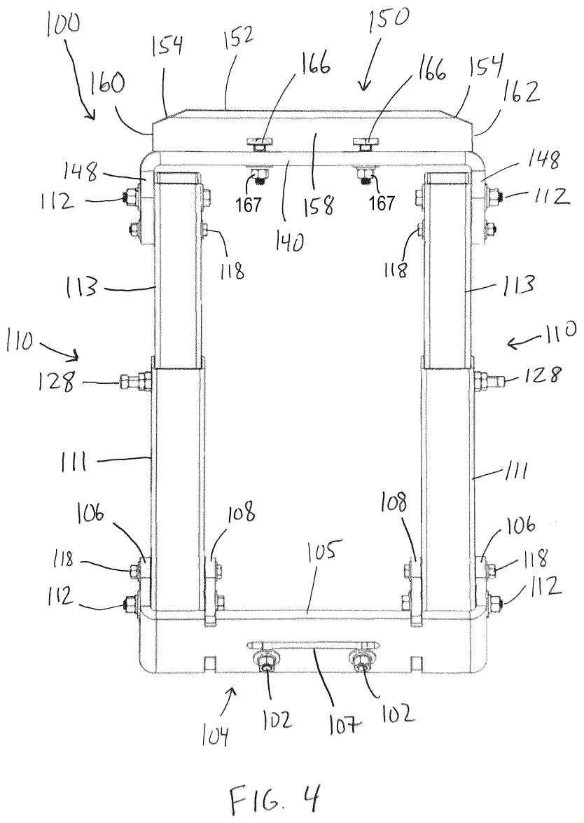

As shown in FIGS. 3-5, a pair of laterally extending T-shaped channels 168 are open to a lateral side surface 158 of the slider bar 150 and extend through and open to the bottom surface 164 thereof for receiving the heads of fasteners such as carriage bolts 166. The lateral orientation of the T-shaped channels 168 is generally perpendicular to the travel direction 18 of the belt 10 to resist shifting of the slider bar 150 on the upper mounting surface 146 of the elongate slider bar mounting member 140 due to friction with the belt 10. The shanks of the carriage bolts 166 extend through spaced apart through openings 170 formed along a longitudinal axis of the rectangular main body portion 142 of slider bar 150 and fixed therein with corresponding nuts. Tightening the nuts causes the head of the carriage bolts 166 to clamp portions of the slider bar 150 therebelow tightly onto the mounting surface 146.

When the slider bar 150 has been worn down, it can easily be replaced by first removing the worn slider bar 150 away from the underside 11 of the belt 10, such as by loosening the set screws 128 and retracting the upper support arm members 113 into the lower support arm members 111. The worn slider bar 150 can then be removed from the elongate slider bar mounting member 140 by either loosening or removing carriage bolt nuts 167 from the carriage bolts 166 and sliding the worn slider bar 150 laterally off of the upper mounting surface 146. To loosen the carriage bolts 166, a user may rotate carriage bolt nuts 167 sufficient to relieve the compressive force applied by the tightened nuts 167 while still leaving the carriage bolt nuts 167 secured to (threaded on) the carriage bolt 166. Loosening without entirely removing a carriage bolt nut 167 from a carriage bolt 166 reduces the likelihood of dropping or losing the nut 167 and of having the carriage bolt 166 fall from the conveyor belt support apparatus 100.

The new slider bar 150 may then be installed in a corresponding manner. The new slider bar 150 can then be positioned into contact with the belt 10 by raising the elongate slider bar mounting member 140 and slider bar 150 into position and retightening the set screws 128 to fix the upper support arm members 113 in place.

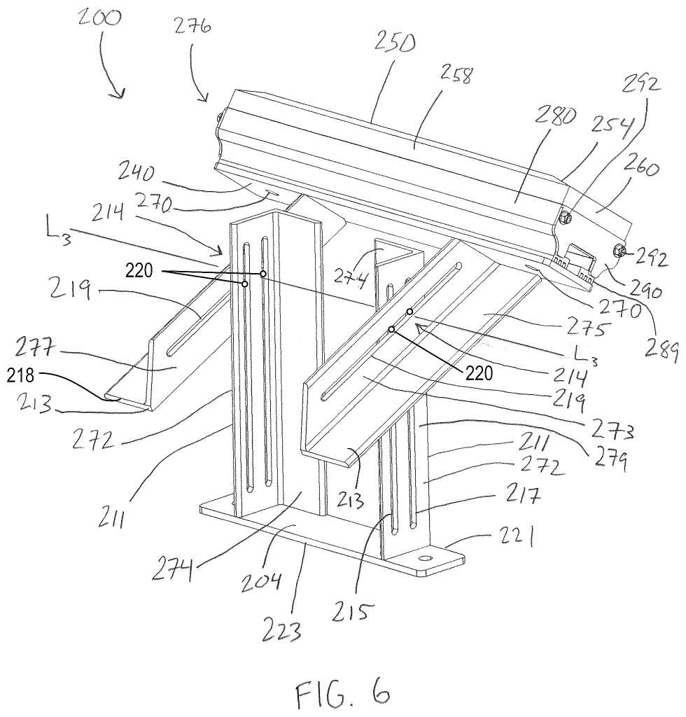

Another conveyor belt support apparatus 200 in accordance with the present disclosure is shown in FIGS. 6-8. This conveyor belt support apparatus 200 is similar to the conveyor belt support apparatus 100 described above, with similar parts being numbered similarly to the parts of conveyor belt support apparatus 100. In particular, the conveyor belt support apparatus 200 includes a generally rectangular base plate member 204 for being mounted to a stringer 16 with fasteners. A pair of spaced apart support arm assemblies include stationary upright support arms 211 that are connected, such as by welding, to an upper surface of the generally rectangular base member 204 to extend vertically upward therefrom. The support arm assemblies also include a pair of movable support arms 213 that are each adjustably connected to the stationary upright support arms 211 via a multi-modal connection 214, which will be described in further detail below. An elongate slider bar mounting member 240 is connected to distal ends of the movable support arms 213, to which a slider bar assembly 276 is removably connected with fasteners. The slider bar assembly 276 includes a slider bar mounting base 280 and a slider bar 250 attached thereto.

In general, the conveyor belt support apparatus 200 has three modes of adjustment to position the slider bar 250 in a desired location underneath a lateral side 12, 14 of the belt 10. However, instead of a rotatable pivot connection 114, 144 at either end of telescoping support arms 110, a connection that is multi-modal connection in the form of a combination translation, pivot and articulation connection 214 between each of the pair of spaced-apart, stationary, upright support arms 211 and a corresponding one of the pair of movable support arms 213 is formed. In a first mode of adjustment, the multi-modal connection 214 allows each movable support arm 213 and the slider bar 250 connected thereto to be translated or shifted vertically along a pair of parallel, elongate longitudinally-extending through slots 215, 217 that extend vertically along a length of stationary upright support arms 211.

In particular, each stationary upright support arm 211 can have an L-shaped cross-sectional configuration and can be an L-shaped angle bar having first and second leg portions 272, 274 defining a right angle therebetween. The stationary upright support arms 211 are arranged such that the second leg portions 274 thereof extend along an laterally inner side 221 of generally rectangular base member 204 that is closer to the center of the conveyor belt and the first leg portions 272 extend transversely or laterally across a width of generally rectangular base member 204, such that the first leg portions 272 of the stationary upright support arms 211 extend in a parallel manner with respect to one another, while the second leg portions 274 of each stationary upright support arms 211 are aligned such that they extend substantially along the same plane. A proximal through slot 215, closest to a laterally outer side 223 of the conveyor belt support apparatus 200 that is further than the inner side 221 from the center of the conveyor belt, and a distal through slot 217, closest to the laterally inner side of the conveyor belt support apparatus 200, each extend along a majority of the length of the stationary upright support arms 211 to maximize the vertical adjustability for the movable support arms 213 along the arms 211. The proximal and distal slots 215, 217 are spaced apart and are each configured to receive a fastener 220 therethrough, such as a bolt, for adjustably connecting movable support arms 213 thereto.

The movable support arms 213 also may have an L-shaped cross-sectional configuration and can be an L-shaped angle bar having first and second leg portions 273, 275 defining a right angle therebetween. The first leg portion 273 of each movable support arm 213 is oriented to be parallel to the corresponding first leg portion 272 of the stationary upright support arms 211. The movable support arms 213 are spaced apart at a distance such that inner facing surfaces 277 of the first leg portions 273 slidingly engage with corresponding outer facing surfaces 279 of first leg portions 272.

The first leg portion 273 includes an elongate through slot 219 extending longitudinally along a majority of the length of the first leg portion 273. The elongate slot 219 is sized and configured to receive a pair of guide members in the form of bolts 220, with one bolt extending through proximal elongate slot 215 and the other bolt 220 extending through distal elongate slot 217 in the corresponding one of the stationary upright support arms 211. Accordingly, the inner facing surfaces 277 of movable support arms 213 and the corresponding outer facing surfaces 279 of stationary upright support arms 211 can be fixedly engaged to one another by tightening nuts onto the corresponding bolts 220. Likewise, adjustments can be made by loosening one or both of the bolts 220 extending through each slot 215 and 217 of both of the arms 213.

Through this multi-modal connection 214, as shown in FIG. 6, the movable support arms 213 are capable of being translated vertically along elongate slots 215, 217, pivoted about a longitudinally extending pivot axis L3 that extends through each elongate slot 219, and translated with respect to the stationary upright support arms 211 and transversely with respect to the longitudinal belt travel direction 18 along elongate slot 219. Accordingly, the slider bar 250 may be adjusted to and fixed at a wide range of positions and orientations with respect to the belt 10. In general, the multi-modal connection 214 may be configured to allow the slider bar 250 to be adjusted to any orientation between a horizontal orientation where it faces directly laterally to a vertical orientation where it faces directly upwardly to allow the slider bar 250 to support the belt 10 in any of a wide variety of positions as needed.

Because of the arrangement of the multi-modal connection 214 with two vertically extending slots 215, 217 connected via bolts 220 extending through the single transversely extending elongate slot 219, the position of the longitudinally extending pivot axis L3 may vary to extend through either of corresponding pairs of aligned bolts 220 in slots 215 or 217 or anywhere along the elongate slot 219 between the pairs of aligned bolts 220. For example, if each aligned bolt pair positioned in slots 215 of each stationary upright support arm 211 is tightened with a corresponding nut, the longitudinally extending pivot axis L3 will be coextensive with the aligned longitudinal axes of the tightened bolts 220 such that the movable support arms 213 will be pivotable about the aligned longitudinal axes of the tightened bolts 220. If all of the bolts 220 in both vertical slots 215, 217 of each stationary upright support arms 211 are loosened, the position of the longitudinally extending pivot axis L3 can be coextensive with the longitudinal axis of either aligned bolt pair or anywhere along elongate slot 219 therebetween, depending on how the movable support arms 213 are manipulated by a user.

The elongate slots 215, 217 and 219 and bolts 220 extending therethrough also define the range of rotational movement of the upper support arm member 113, which is generally dependent on both the position of the bolts 220 within elongate slots 215, 217, 219 and the length of the elongate slots 215, 217, 219. In the embodiment shown, the upper support arm member 113 may be pivoted at least 90 degrees about the longitudinally extending pivot axis L3.

In another form, instead of continuous elongate slots 215, 217, 219, one or more of the slots could be replaced with separate spaced apart through openings arranged in similar axial orientations to the elongate slots 215, 217, 219 to allow discrete vertical, angular, and/or translational adjustment, and combinations thereof, of the support arms 113.

A generally rectangular plate-like slider bar mounting member 240 for supporting the slider bar assembly 276 is fixedly connected to distal ends of the movable support arms 213, such as by welding, with the distal ends being cut so that the plane of the plate-like mounting member 240 is at an inclined angle, such as 45 degrees, with respect to a longitudinal axis 213a of the movable support arms 213. Other angular orientations may be used as desired. The angular orientation of the plate-like mounting member 240 relative to the longitudinal axis 213a of the movable support arms 213 may be selected so that the mounting member 240 and top flat surface 252 of the slider bar 250 parallel therewith will be oriented at an angle to the horizontal similar to that of typical angles at which troughed side portions of troughed conveyor belts 10 are oriented, such as shown in FIG. 1. Such angles may be in the range of approximately 20 to approximately 45 degrees.

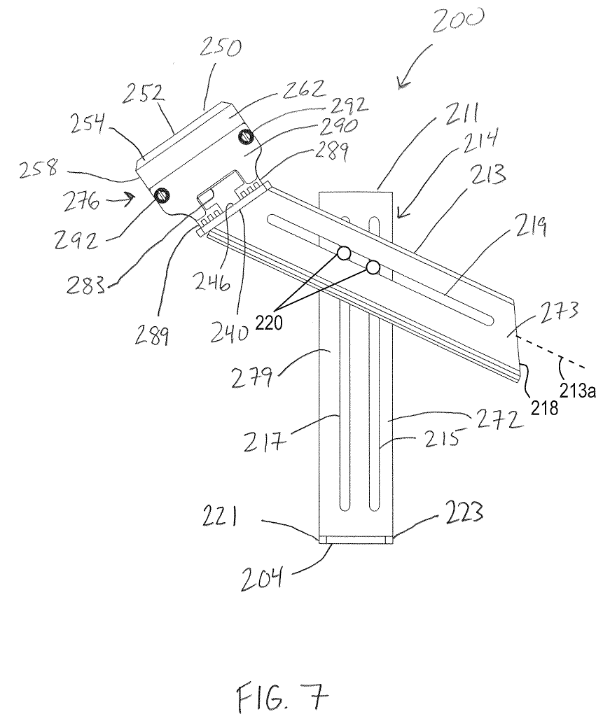

Furthermore, by having this relatively shallow angular orientation of the mounting member 240 relative to the longitudinal axis 213a, a substantial range of vertical adjustability of the movable support arms 213 along the corresponding upright support arms 211 can be maintained. More particularly, a steep angular orientation of the plate-like mounting member 240 relative to the longitudinal axis 213a of the movable support arms 213, such as approaching closer to 90 degrees, while maintaining a desired orientation of the slider bar 250 relative to a troughing angle of a conveyor belt 10, results in a free end portion 218 of the movable support arms 213 being positioned closer to the generally rectangular base member 204 than is shown in FIGS. 6 and 7. This may restrict the use of the conveyor belt support apparatus 200 where the corresponding side of the conveyor belt 10 is not spaced above the conveyor structure to which the base member 204 is mounted by a sufficient distance. On the other hand, a shallower angle of the plate-like mounting member 240 relative to the longitudinal axis 213a of the movable support arms 213 (e.g., 15-60 degrees) allows for greater vertical adjustability of the movable support arms 213 so as to reduce the need for a greater vertical distance between the conveyor structure to which the mounting member 240 is secured and the corresponding side of the conveyor belt 10. In addition, the shallower angle allows for greater lateral adjustability of the movable support arms 213 across the stationary support arms 211 for a given length of the respective slots 219 and 217 thereof.

In another form, the slider bar support member 240 can be rotatably mounted to the movable support arms 213, such as in a similar manner to elongate slider bar mounting member 140.

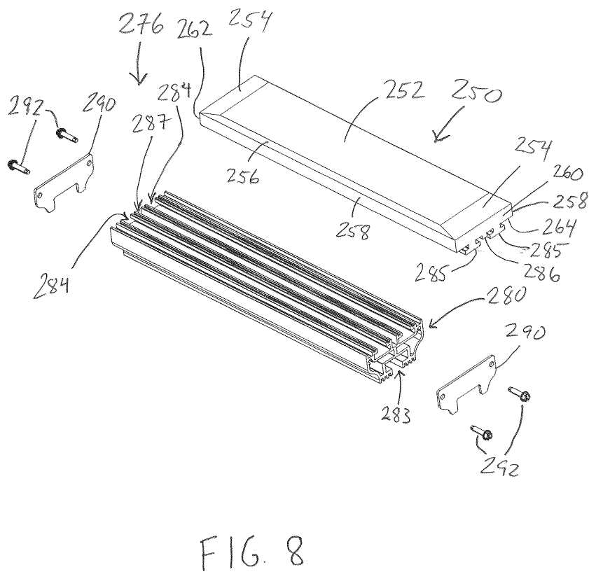

Slider bar assembly 276, including slider bar 250 mounted to a slider bar mounting base 280, is attached to the slider bar support member 240 with carriage bolts or the like through apertures 270 at opposing end portions of the slider bar support member 240. Referring now to FIG. 8, the slider bar mounting base 280 may be formed of an extruded material, such as aluminum, and includes a lower mounting channel 283 that extends longitudinally from one end to the other and has a T-shaped cross-sectional configuration for receiving the heads of the carriage bolts for mounting the slider bar mounting base 280 to the slider bar support member 240 with adjacent elongate foot portions 289 in engagement with upper mounting surface 246 of slider bar support member 240. The slider bar mounting base 280 also includes two parallel, longitudinally extending upper mounting channels 284 having T-shaped cross-sectional configurations for receiving corresponding T-shaped elongate mounting legs 285 extending from a bottom surface 264 of the slider bar 250. A central, longitudinally extending rib member 286 is positioned between the T-shaped elongate mounting legs 285 for being received in a corresponding central, longitudinally extending channel 287 formed between the upper mounting channels 284. The slider bar assembly 276 may be similar to what is shown in U.S. Pat. No. 9,296,564, which is incorporated by reference in its entirety herein.

The slider bar 250 is similar to slider bar 150 described above, except with respect to the structure for mounting the slider bar 250 to the slider bar mounting base 280. In particular, slider bar 250 has a generally rectangular prismatic shape with a top surface 252 for engaging with the underside of the conveyor belt 10. Beveled surface portions 254 are positioned at each end between the top surface 252 and the leading and trailing end surfaces 260, 262 to reduce friction with the belt 10 and to avoid catching on splices or other protrusions on the underside of the belt 10. Narrower beveled surface portions 256 extend between the top surface 252 and lateral side surfaces 258.

End cap plate members 290 are secured at either end of the slider bar mounting base 280 to act as stops to keep the slider bar 250 and the T-shaped elongate mounting protrusions 285 thereof from shifting longitudinally with respect to the slider bar mounting base 280 due to engagement with the belt 10. The end cap members 290 also keep dust and debris from entering the slider bar mounting base 280, including the upper mounting channels 284 thereof, which can cause the slider bar 250 to become stuck to the slider bar mounting base 280.

When the slider bar 250 has been worn down, it can be replaced by first shifting the worn slider bar 250 away from the underside 11 of the belt 10, such as by loosening the fasteners of the multi-modal connection 214 and lowering, pivoting, and/or articulating the movable support arms 213 for this purpose. The worn slider bar 250 can then be removed from the slider bar mounting base 280 by loosening the end cap fasteners 292 to allow removal of one of the end cap members 290. The worn slider bar 250 may then be slid longitudinally to remove the corresponding T-shaped elongate mounting legs 285 from the corresponding upper mounting channels 284. The new slider bar 250 may then be installed in a reverse manner. The new slider bar 250 can then be shifted into contact with the belt 10 by raising, pivoting, and/or articulating the movable support arms 213 and the slider bar assembly 276 into engagement with the conveyor belt and retightening the fasteners of the multi-modal connection 214 to fix the upper support arm members 113 in place.

Those skilled in the art will recognize that a wide variety of modifications, alterations, and combinations can be made with respect to the above-described embodiments without departing from the spirit and scope of the invention, and that such modifications, alterations, and combinations are to be viewed as being within the scope of the claims.

1. An apparatus for supporting a conveyor belt, comprising:
a base member configured to be mounted adjacent to a lateral side of the conveyor belt;
at least one support arm assembly having proximal and distal end portions, with the proximal end portion being connected to the base member;
a slider bar mounting member operably connected to the distal end portion of the at least one support arm assembly;
a slider bar operably mounted to the slider bar mounting member, wherein the slider bar comprises a belt support surface for slidingly supporting the conveyor belt as the conveyor belt travels in a longitudinal belt travel direction along the slider bar; and
a plurality of different modes of adjustment of the slider bar, wherein the plurality of different modes of adjustment include movement of the slider bar in an arcuate path relative to the base member and translational shifting of the slider bar in an oblique direction that extends obliquely relative to a vertical direction and a lateral direction, wherein the lateral direction is perpendicular to the longitudinal belt travel direction.

2. The apparatus of claim 1, wherein the at least one support arm assembly comprises a pair of support arm assemblies that are operably connected to the base member at opposite ends thereof.

3. The apparatus of claim 1, wherein the base member is configured to be mounted to a surface having one of a plurality of different orientations, wherein the plurality of different orientations include a horizontal orientation, a vertical orientation, and at least one orientation other than horizontal and vertical, wherein the plurality of different modes of adjustment allow the belt support surface to be oriented to slidingly support the conveyor belt with the base member mounted to the surface having any of the plurality of different orientations.

4. The apparatus of claim 1, wherein the at least one support arm assembly is operably connected to the base member via a rotatable pivot connection to allow the at least one support arm assembly to be rotated with respect to the base member.

5. The apparatus of claim 4, wherein the rotatable pivot connection comprises a pair of spaced-apart trunnions extending outwardly from the base member and an elongate pivot member operably connected to the proximal end portion of the at least one support arm assembly about which the at least one support arm assembly is rotatable, wherein the proximal end portion of the at least one support arm assembly is positioned between the spaced-apart trunnions with the pivot member operably connected to each of the trunnions.

6. The apparatus of claim 5, wherein each trunnion comprises an arcuate channel in which a portion of a guide member is received for defining a range of rotational movement of the at least one support arm assembly, wherein the guide member is operably connected to the proximal end portion of the at least one support arm assembly.

7. The apparatus of claim 6, wherein at least one of the arcuate channels comprises a plurality of projections of opposing side surfaces of the at least one of the arcuate channels spaced so that adjacent ones of the plurality of projections tightly engage with the guide member received therebetween to inhibit rotation of the at least one support arm assembly relative to the base member.

8. The apparatus of claim 1, wherein the slider bar mounting member is operably connected to the distal end portion of the at least one support arm assembly via a rotatable pivot connection to allow the slider bar mounting member, the slider bar and the belt support surface thereof to be rotated with respect to the at least one support arm assembly.

9. The apparatus of claim 8, wherein the slider bar mounting member comprises an elongate upper mounting surface to which the slider bar is mounted, wherein the slider bar comprises a pair of t-shaped channels each configured for receiving a corresponding portion of a fastener extending from the elongate upper mounting surface of the slider bar mounting member.

10. The apparatus of claim 1, wherein the at least one support arm assembly comprises an upright support arm extending upwardly from the base member, and a movable support arm that is operably connected to the upright support arm via a multi-modal connection that allows the movable support arm to be rotated relative to the upright support arm, to be shifted vertically with respect to the upright support arm, and to be translated along a longitudinal axis of the movable support arm.

11. The apparatus of claim 10, wherein the multi-modal connection comprises two longitudinally-extending slots in the upright support arm, a longitudinally-extending slot in the movable support arm, and a pair of fasteners, wherein the pair of fasteners extend through the two longitudinally-extending slots in the upright support arm and the longitudinally-extending slot in the movable support arm.

12. An apparatus for supporting a conveyor belt traveling in a longitudinal belt travel direction, the apparatus comprising:
an elongate base member;
a pair of spaced apart support arms each having a proximal end portion and a distal end portion, with the proximal end portions connected to the elongate base member via a pair of first rotatable pivot connections to allow the support arms to rotate relative to the elongate base member;
an elongate slider bar mounting member operably connected to the distal end portions of the support arms via a pair of second rotatable pivot connections to allow the slider bar mounting member to rotate relative to the support arms; and
an elongate slider bar operably mounted to an elongate upper mounting surface of the slider bar mounting member, wherein the elongate slider bar comprises a belt support surface for slidingly supporting the conveyor belt as the conveyor belt travels along the slider bar, the elongate slider bar being adjustable to different lateral and vertical positions for supporting a side edge portion of the conveyor belt via the first and second rotatable pivot connections.

13. The apparatus of claim 12, wherein each of the support arms comprises an upper support arm member adjustably received inside of a lower support arm member in a telescoping manner.

14. The apparatus of claim 12, wherein the elongate base member comprises a longitudinal axis;
wherein the pair of first rotatable pivot connections comprise a first pivot axis about which the support arms are configured to rotate;
wherein the pair of second rotatable pivot connections comprise a second pivot axis about which the elongate slider bar mounting member is configured to rotate; and
wherein first and second pivot axes are parallel to each other and to the longitudinal axis of the elongate base member.

15. The apparatus of claim 12, wherein each of the first rotatable pivot connections comprises a pair of spaced-apart trunnions extending outwardly from a main body of the base member and an elongate pivot member operably connected to the proximal end portion of one of the support arms and the corresponding spaced-apart trunnions to allow the support arms to rotate about the corresponding pivot members.

16. The apparatus of claim 12, wherein the pair of spaced-apart trunnions each comprise an arcuate channel in which a portion of a guide member is received for defining a range of rotational movement of the corresponding support arm, wherein the guide member is operably connected to the proximal end portion of the corresponding support arm.

17. The apparatus of claim 16, wherein at least one of the arcuate channels comprises a plurality of projections of opposing side surfaces of the at least one of the arcuate channels spaced so that adjacent ones of the plurality of projections tightly engage with the guide member received therebetween to inhibit rotation of the corresponding support arm relative to the base member.

18. The apparatus of claim 12, wherein the elongate slider bar mounting member comprises opposing trunnions extending transversely with respect to the elongate upper mounting surface of the slider bar mounting member surface, wherein each of the opposing trunnions comprises an arcuate channel in which a portion of a guide member is received for defining a range of rotational movement of the elongate slider bar mounting member, wherein the guide member is operably connected to the distal end portion of the corresponding support arm.

19. The apparatus of claim 18, wherein at least one of the arcuate channels of the opposing trunnions of the elongate slider bar mounting member comprises a plurality of projections of opposing side surfaces of the at least one of the arcuate channels spaced so that adjacent ones of the plurality of projections tightly engage with the guide member received therebetween to inhibit rotation of the elongate slider bar mounting member relative to the support arms.

20. The apparatus of claim 12, wherein the elongate base member is configured to be mounted to a surface having one of a plurality of different orientations, wherein the plurality of different orientations include a horizontal orientation, a vertical orientation, and at least one orientation other than horizontal and vertical, wherein the support arms and the pairs of first and second rotatable pivot connections allow the belt support surface to be oriented to slidingly support the conveyor belt with the elongate base member mounted to the surface having any of the plurality of different orientations.
